(19) United States
(12) Patent Application Publication
(10) Pub. No.: US 2022/0130141 A1
(43) Pub. Date: Apr. 28, 2022

(54) IMAGE PROCESSING METHOD AND APPARATUS, ELECTRONIC DEVICE, AND COMPUTER READABLE STORAGE MEDIUM

(71) Applicant: Shanghai SenseTime Lingang Intelligent Technology Co., Ltd., Shanghal (CN)

(72) Inventors: Kewen Wang, Shanghai (CN); Guangliang Cheng, Shanghai (CN)

(21) Appl. No.: 17/573,366

(22) Filed: Jan. 11, 2022

Related U.S. Application Data
(63) Continuation of application No. PCT/CN2021/071581, filed on Jan. 13, 2021.

(30) Foreign Application Priority Data
Jan. 19, 2020 (CN) 202010062779.5

(51) Int. Cl. G06V 10/80; G06T 7/11; G06T 7/194; G06V 10/46

(52) U.S. Cl. CPC G06V 10/806; G06T 7/11; G06V 10/809; G06V 10/462; G06T 7/194

(57) ABSTRACT

Methods, apparatuses, electronic devices, and computer readable storage media for image processing are provided. In one aspect, an image processing method includes: determining a plurality of image feature maps of a target image, the plurality of image feature maps corresponding to different preset scales; determining, based on the plurality of image feature maps and for each pixel of pixels in the target image, a first probability that the pixel in the target image belongs to a foreground and a second probability that the pixel in the target image belongs to a background; and performing panoramic segmentation on the target image based on the plurality of image feature maps, the first probabilities of the pixels in the target image, and the second probabilities of the pixels in the target image.

### CROSS-REFERENCE TO RELATED APPLICATION

The present application is a continuation of International Application No. PCT/CN2021/071581, filed on Jan. 13, 2021, which claims a priority of the Chinese patent application No. CN202010062779.5 filed on Jan. 19, 2020, all of which are incorporated herein by reference in their entireties.

### TECHNICAL FIELD

The present disclosure relates to the fields of computer technologies and image processing, and in particular, to an image processing method and apparatus, an electronic device, and a computer readable storage medium.

### BACKGROUND

Automated driving as an emerging cutting-edge technology has been studied by many research institutes and institutions. Scene perception is the basis of an automated driving technology. Accurate scene perception helps provide an accurate control signal for automated driving, so as to improve precision and safety of automated driving control.

Scene perception is used to perform panoramic segmentation on an image, predict an instance class of each object in the image, and determine a bounding box of each object. Then, the automated driving technology generates, based on the predicted instance class and bounding box, a control signal for controlling driving of an automated driving component. Currently, a defect of low prediction precision exists in scene perception.

### SUMMARY

In view of this, the present disclosure provides at least one image processing method and apparatus, an electronic device, a computer readable storage medium, and a computer program.

According to a first aspect, the present disclosure provides an image processing method, including: determining a plurality of image feature maps of a target image that correspond to different preset scales; determining, based on the plurality of image feature maps, a first probability that each pixel in the target image belongs to a foreground and a second probability that each pixel in the target image belongs to a background; and performing panoramic segmentation on the target image based on the plurality of image feature maps, the first probability that each pixel in the target image belongs to the foreground, and the second probability that each pixel in the target image belongs to the background.

In an embodiment, where determining the plurality of image feature maps of the target image includes: performing feature extraction on the target image to obtain a respective first feature map for each of the different preset scales; splicing the respective first feature maps for the different preset scales to obtain a first spliced feature map; extracting an image feature from the first spliced feature map to obtain a second feature map corresponding to a maximum preset scale in the different preset scales; and determining, based on the respective first feature maps for the different preset scales and the second feature map corresponding to the maximum preset scale, the plurality of image feature maps corresponding to the different preset scales.

In an embodiment, where determining, based on the respective first feature maps for the different preset scales and the second feature map corresponding to the maximum preset scale, the plurality of image feature maps corresponding to the different preset scales includes: for each of the different preset scales except the maximum preset scale, determining, based on the second feature map corresponding to the maximum preset scale and the respective first feature map for an adjacent preset scale that is adjacent to the preset scale and greater than the preset scale in the different preset scales, a second feature map corresponding to the preset scale; and determining, based on the respective first feature map corresponding to the preset scale and the second feature map corresponding to the preset scale, an image feature map corresponding to the preset scale.

In an embodiment, where splicing the respective first feature maps for the different preset scales to obtain a first spliced feature map includes: for each of the different preset scales except the maximum preset scale, performing upsampling processing on the respective first feature map for the preset scale to obtain a first upsampled feature map having a scale identical to the maximum preset scale; and splicing the respective first feature map corresponding to the maximum preset scale and the first upsampled feature maps for the different preset scales except the maximum preset scales to obtain the first spliced feature map.

In an embodiment, where determining, based on the plurality of image feature maps and for each pixel in the target image, the first probability that the pixel in the target image belongs to the foreground and the second probability that the pixel in the target image belongs to the background includes: for each of the different preset scales except a maximum preset scale, performing upsampling processing on an image feature map corresponding to the preset scale to obtain an upsampled image feature map having a scale identical to the maximum preset scale; splicing an image feature map corresponding to the maximum preset scale and the upsampled image feature maps for the different preset scales except the maximum preset scale to obtain a second spliced feature map; and determining, based on the second spliced feature map and for each pixel in the target image, the first probability that the pixel in the target image belongs to the foreground and the second probability that the pixel in the target image belongs to the background.

In an embodiment, where performing panoramic segmentation on the target image based on the plurality of image feature maps, the first probabilities for the pixels in the target image, and the second probabilities for the pixels in the target image includes: determining semantic segmentation logits according to the second spliced feature map and the second probabilities for the pixels in the target image, wherein a first scaling ratio corresponding to a pixel in the target image is a ratio of a value corresponding to the pixel in the semantic segmentation logits to a value corresponding to the pixel in the second spliced feature map, and wherein a pixel in the target image having a higher second probability corresponds to a larger first scaling ratio; determining an initial bounding box, an initial instance class, and instance segmentation logits of each object in the target image according to the second spliced feature map and the first probabilities for the pixels in the target image, wherein a second scaling ratio corresponding to a pixel in the target image is a ratio of a value corresponding to the pixel in the instance segmentation logits to a value corresponding to the pixel in the second spliced feature map, and wherein a pixel in the target image having a higher first probability corresponds to a larger second scaling ratio; for each object in the target image, determining respective semantic segmentation logits corresponding to the object from the semantic segmentation logits according to the initial bounding box and the initial instance class of the object; determining panoramic segmentation logits of the target image according to the respective semantic segmentation logits and the instance segmentation logits that correspond to each object; and determining a bounding box and an instance class of each of objects in the background and the foreground of the target image according to the panoramic segmentation logits of the target image.

In an embodiment, where determining the semantic segmentation logits according to the second spliced feature map and the second probabilities of the pixels in the target image includes: determining a foreground-background classification feature map by using the first probabilities of the pixels in the target image and the second probabilities of the pixels in the target image; extracting an image feature from the foreground-background classification feature map to obtain a feature map; obtaining a first processed feature map by enhancing feature pixels that are in the feature map and correspond to the background in the target image and weakening feature pixels that are in the feature map and correspond to the foreground in the target image; fusing the first processed feature map with the second spliced feature map to obtain a fused feature map; and determining the semantic segmentation logits based on the fused feature map.

In an embodiment, where determining an initial bounding box, an initial instance class, and instance segmentation logits of each object in the target image according to the second spliced feature map and the first probabilities of the pixels in the target image includes: determining a foreground-background classification feature map by using the first probabilities of the pixels in the target image and the second probabilities of the pixels in the target image; extracting an image feature from the foreground-background classification feature map to obtain a feature map; obtaining a second processed feature map by enhancing feature pixels that are in the feature map and correspond to the foreground in the target image and weakening feature pixels that are in the feature map and correspond to the background in the target image; fusing the second processed feature map with a region of interest corresponding to each object in the second spliced feature map to obtain a fused feature map; and for each object in the target image, determining the initial bounding box, the initial instance class, and the instance segmentation logits based on the fused feature map.

In an embodiment, where the image processing method is performed by a neural network that is trained by using a sample image, and where the sample image includes an instance class and mask information annotated for each object in the sample image.

In an embodiment, where the neural network is trained by: determining a plurality of sample image feature maps of the sample image, the plurality of sample image feature maps corresponding to the different preset scales; determining, for each pixel of pixels in the sample image, a first sample probability that the pixel in the sample image belongs to the foreground and a second sample probability that the pixel in the sample image belongs to the background; performing panoramic segmentation on the sample image according to the plurality of sample image feature maps, the first sample probabilities of the pixels in the sample image, and the second sample probabilities of the pixels in the sample image to output an instance class and mask information of each object in the sample image; determining a network loss function based on the mask information of each object in the sample image that is outputted by the neural network and mask information annotated for each object in the sample image; and adjusting a network parameter in the neural network by using the network loss function.

In an embodiment, where determining the network loss function based on the mask information of each object in the sample image that is outputted by the neural network and mask information annotated for each object includes: obtaining mask intersection information by determining, for each object in the sample image, identical information between the mask information outputted by the neural network and the mask information annotated in the sample image; obtaining mask union information by determining, for each object in the sample image, combined information between the mask information outputted by the neural network and the mask information annotated in the sample image; and determining the network loss function based on the mask intersection information and the mask union information.

According to a second aspect, the present disclosure provides an image processing apparatus, including: a feature map determining module, configured to determine a plurality of image feature maps of a target image that correspond to different preset scales; a foreground-background processing module, configured to determine, based on the plurality of image feature maps, a first probability that each pixel in the target image belongs to a foreground and a second probability that each pixel in the target image belongs to a background; and a panoramic analysis module, configured to perform panoramic segmentation on the target image based on the plurality of image feature maps, the first probability that each pixel in the target image belongs to the foreground, and the second probability that each pixel in the target image belongs to the background.

According to a third aspect, the present disclosure provides an electronic device, including a processor, a memory, and a bus. The memory stores machine readable instructions executable by the processor. When the electronic device runs, the processor communicates with the memory by using the bus, and the machine readable instructions are executed by the processor to perform the steps of the foregoing image processing method.

According to a fourth aspect, the present disclosure further provides a computer readable storage medium storing a computer program, and the computer program is run by a processor to perform the steps of the foregoing image processing method.

According to a fifth aspect, the present disclosure further provides a computer program, stored in a storage medium, where when the computer program is run by a processor, the steps of the foregoing image processing method are performed.

The apparatus, the electronic device, the computer readable storage medium, and the computer program in the present disclosure include at least a technical feature substantially the same as or similar to the technical feature of any aspect or any implementation of any aspect of the foregoing method in the present disclosure. Therefore, for an effect description of the apparatus, the electronic device, the computer readable storage medium, and the computer program, refer to the following effect description in the detailed description of the embodiments. Details are not described herein.

### BRIEF DESCRIPTION OF THE DRAWINGS

To describe the technical solutions of the embodiments of the present disclosure more clearly, the following briefly describes the accompanying drawings required for describing the embodiments. It should be understood that the following accompanying drawings show only some embodiments of the present disclosure, which cannot be considered as limitation on the scope. A person of ordinary skill in the art may still derive other accompanying drawings from the accompanying drawings without inventive efforts.

FIG. 1 is a flowchart of an image processing method according to an embodiment of the present disclosure.

FIG. 2 is a schematic diagram of a neural network for generating an image feature map according to an embodiment of the present disclosure.

FIG. 3 is a schematic diagram of a process of determining a plurality of image feature maps of a target image that correspond to different preset scales according to an embodiment of the present disclosure.

FIG. 4 is a schematic diagram of a process of determining, based on a plurality of image feature maps, a first probability that each pixel in a target image belongs to a foreground and a second probability that each pixel in the target image belongs to a background according to an embodiment of the present disclosure.

FIG. 5 is a schematic diagram of a process of performing panoramic segmentation on a target image based on a plurality of image feature maps, a first probability that each pixel in the target image belongs to a foreground, and a second probability that each pixel in the target image belongs to a background according to an embodiment of the present disclosure.

FIG. 6 is a schematic diagram of a process of generating an instance segmentation logit by a convolutional neural network according to an embodiment of the present disclosure.

FIG. 7 is a flowchart of an image processing method according to an embodiment of the present disclosure.

FIG. 8 is a schematic structural diagram of an image processing apparatus according to an embodiment of the present disclosure.

FIG. 9 is a schematic structural diagram of an electronic device according to an embodiment of the present disclosure.

### DETAILED DESCRIPTION OF THE EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. It should be understood that the accompanying drawings in the present disclosure serve only the purpose of description and illustration, and are not intended to limit the protection scope of the present disclosure. In addition, it should be understood that the schematic accompanying drawings are not drawn in a physical proportion. The flowcharts used in the present disclosure illustrate operations implemented according to some embodiments of the present disclosure. It should be understood that operations in the flowcharts may not be implemented in a sequence, and steps without a logical context relationship may be implemented reversely or at the same time. In addition, a person skilled in the art may add one or more other operations to a flowchart, or may remove one or more operations from the flowchart under the guidance of the present disclosure.

In addition, the described embodiments are merely some but not all of the embodiments of this application. In general, the components of the embodiments of the present disclosure, which are described and illustrated herein in the accompanying drawings, may be arranged and designed in various configurations. Therefore, the following detailed descriptions of the embodiments of the present disclosure provided in the accompanying drawings are not intended to limit the protection scope of the present disclosure, but are only intended to represent the selected embodiments of the present disclosure. All other embodiments obtained by a person of ordinary skill in the art based on the embodiments of the present disclosure without inventive efforts shall fall within the protection scope of the present disclosure.

To enable a person skilled in the art to use the content of the present disclosure, the following implementations are provided with reference to a specific application scenario “scene perception used in an automated driving technology”. A person skilled in the art may apply, without departing from the spirit and scope of the present disclosure, a general principle defined herein to another embodiment and application scenario in which scene perception needs to be performed. Although the present disclosure mainly focuses on scene perception used in the automated driving technology, it should be understood that this is merely an exemplary embodiment.

It should be noted that, in the embodiments of the present disclosure, the term “include” is used to indicate existence of a subsequently declared feature, but addition of another feature is not excluded.

To improve accuracy of panoramic segmentation in scene perception, the present disclosure provides an image processing method and apparatus, an electronic device, and a computer readable storage medium. In the present disclosure, a first probability that each pixel in a target image belongs to a foreground and a second probability that each pixel in the target image belongs to a background are determined based on image feature maps of a target image that correspond to different preset scales. By using the first probability and the second probability, enhancement or weakening processing is performed on a pixel in the image feature map based on an actual segmentation requirement, thereby highlighting the background or the foreground in the target image, and further implementing precise segmentation on different objects and on an object and the background in the target image, that is, helping improve accuracy of panoramic segmentation.

The following describes the image processing method and apparatus, the electronic device, and the computer readable storage medium in the present disclosure by using specific embodiments.

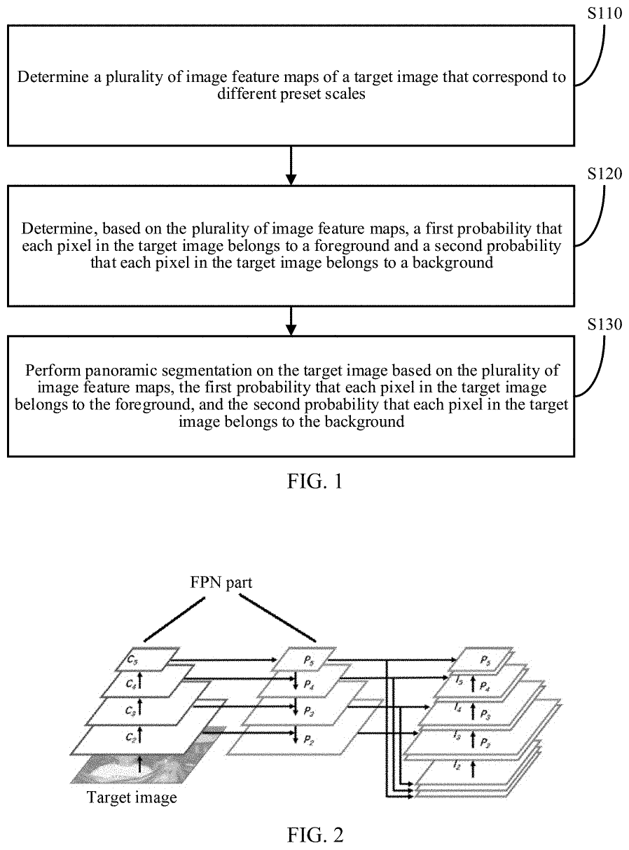

An embodiment of the present disclosure provides an image processing method, and the method is applied to a terminal device for perceiving a scene, that is, performing panoramic segmentation on an image. As shown in FIG. 1, the image processing method provided in this embodiment of the present disclosure includes the following steps S110 to S130.

At step S110, a plurality of image feature maps of a target image that correspond to different preset scales are determined.

In this embodiment of the present disclosure, the target image may be an image photographed by an automated driving device by using a camera in a driving process.

In this embodiment of the present disclosure, the image feature maps for the different preset scales may be obtained after a convolutional neural network processes an inputted image or feature map. In some embodiments, the different preset scales may include 1/32 scale, 1/16 scale, ⅛ scale, and ¼ scale of an image.

At step S120, based on the plurality of image feature maps, a first probability that each pixel in the target image belongs to a foreground and a second probability that each pixel in the target image belongs to a background are determined.

In this embodiment of the present disclosure, upsampling processing may be first performed on the plurality of image feature maps, so that after the image feature maps for different preset scales have the same scale, all upsampled image feature maps are spliced, and then the first probability that each pixel in the target image belongs to the foreground and the second probability that each pixel in the target image belongs to the background are determined based on the spliced feature map.

At step S130, based on the plurality of image feature maps, the first probability that each pixel in the target image belongs to the foreground, and the second probability that each pixel in the target image belongs to the background panoramic segmentation on the target image is performed.

In this embodiment of the present disclosure, if panoramic segmentation is performed on the target image, a bounding box and an instance class of an object in the background and the foreground of the target image can be determined.

In this embodiment of the present disclosure, enhancement processing may be performed, based on the first probability and the second probability, on feature pixels in the image feature map and corresponding to the foreground and the background in the target image, thereby facilitating precise segmentation of a pixel in the target image, that is, helping improve accuracy of performing panoramic segmentation on the target image.

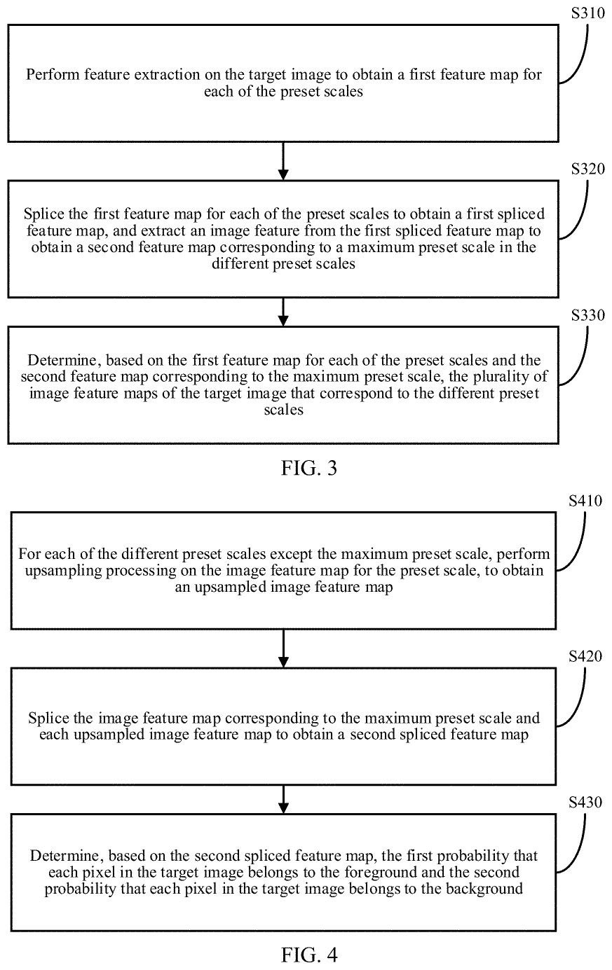

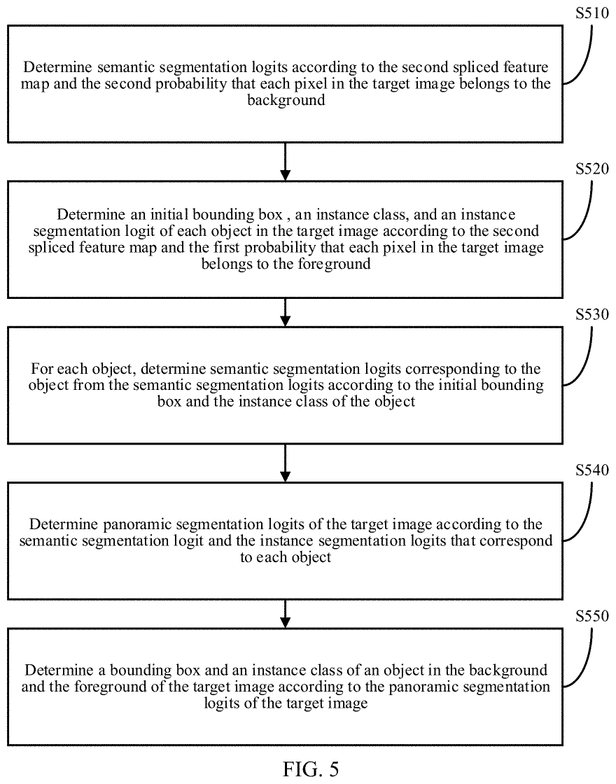

In some embodiments, as shown in FIG. 3, determining the plurality of image feature maps of a target image that correspond to different preset scales may be implemented by using the following steps S310 to S330.

At step S310, feature extraction on the target image is performed, to obtain a first feature map for each of the preset scales.

In this embodiment of the present disclosure, a convolutional neural network may be used to perform feature extraction on an inputted image or a feature map to obtain the first feature map corresponding to each of the preset scales. For example, in FIG. 2, the first feature maps respectively corresponding to the preset scales, that is, feature maps P₂, P₃, P₄, and P₅ outputted by the convolutional neural network, may be determined by using a feature pyramid networks (FPN) part of a multi-scale target detection algorithm.

In FIG. 2, C₂, C₃, C₄, and C₅ respectively correspond to bottom-up convolution results of the convolutional neural network, and P₂, P₃, P₄, and P₅ are feature maps which respectively correspond to these convolution results. C₂ and P₂ have identical preset scale, C₃ and P₃ have identical preset scale, C₄ and P₄ have identical preset scale, and C₅ and P₅ have identical preset scale. The feature map P₂ is a feature map obtained by directly performing feature extraction on the target image by using the convolutional neural network, and all other feature maps are feature maps obtained by performing feature extraction on a previous feature map by using the convolutional neural network.

At step S320, the first feature map for each of the preset scales is sliced to obtain a first spliced feature map, and an image feature is extracted from the first spliced feature map to obtain a second feature map corresponding to a maximum preset scale in the different preset scales.

In this embodiment of the present disclosure, before the first feature maps of the different preset scales are spliced, upsampling processing needs to be further performed on a first feature map corresponding to each preset scale in the different preset scales except the maximum preset scale. All upsampled first feature maps are feature maps with the maximum preset scale. Then, all the first feature maps with the maximum preset scale are spliced.

In step S320, upsampling processing is performed on a first feature map that is less than the maximum preset scale, so that all the upsampled first feature maps are spliced only after they have the identical scale, thereby ensuring accuracy of feature map splicing, and helping improve accuracy of performing panoramic segmentation on the target image.

In this embodiment of the present disclosure, the convolutional neural network may be used to perform feature extraction on the first spliced feature map to obtain a second feature map, for example, the feature map corresponding to the maximum preset scale, such as a feature map l₂ in FIG. 2.

At step S330, based on the first feature map for each of the preset scales and the second feature map corresponding to the maximum preset scale, the plurality of image feature maps of the target image that correspond to the different preset scales are determined.

In some embodiments, a second feature map for each of the preset scales may be successively generated in descending order of the preset scales and with reference to the first feature map corresponding to each of the preset scales, and then a final image feature map for each of preset scales is determined with reference to the first feature map and the second feature map. In this way, feature extraction and fusion are performed for a plurality of times and in a plurality of directions, which can more fully explore image feature information in the target image to obtain a more complete and accurate feature map, thereby improving accuracy of performing panoramic segmentation on the target image.

In implementation, step S330 may be implemented by using the following sub-steps 3301 to 3302.

At sub-step 3301, for each of the preset scales except the maximum preset scale, based on a first feature map of a preset scale that is adjacent to the preset scale and that is greater than the preset scale and the second feature map corresponding to the maximum preset scale, a second feature map corresponding to the preset scale is determined.

In some embodiments, the preset scales are stored in ascending order. For an i^{th} preset scale, a first feature map corresponding to an (i+1)^{th} preset scale that is adjacent to the i^{th} preset scale and that is greater than the i^{th} preset scale and a second feature map corresponding to the (i+1)^{th} preset scale are spliced, and then the convolutional neural network is used to perform feature extraction to obtain a second feature map corresponding to the i^{th} preset scale, such as second feature maps l₃, l₄, and l₅ in FIG. 2, where i is less than or equal to a difference between a quantity of preset scales and l.

At sub-step 3302, for each of the preset scales, based on the first feature map corresponding to the preset scale and the second feature map corresponding to the preset scale, an image feature map of the target image that corresponds to the preset scale is determined.

In this embodiment of the present disclosure, the first feature map and the second feature map that correspond to each of the preset scales are spliced, and then the convolutional neural network is used to perform feature extraction to obtain the image feature map corresponding to each of the preset scales.

In the foregoing embodiment, a second feature map for a current preset scale is determined in descending order of preset scales and with reference to a first feature map and a second feature map for a previous preset scale, and then an image feature map for the current preset scale is finally determined based on the second feature map and a first feature map for the current preset scale. Therefore, when the image feature map corresponding to each of the preset scales is determined, information about feature maps corresponding to other preset scales is fully fused, which can more fully explore the image feature information in the target image, thereby improving accuracy and integrity of the image feature map corresponding to each preset scale.

In some embodiments, as shown in FIG. 4, determining, based on the plurality of image feature maps, the first probability that each pixel in the target image belongs to the foreground and the second probability that each pixel in the target image belongs to the background may be implemented by using the following steps S410 to S430.

At step S410, for each of the different preset scales except the maximum preset scale, upsampling processing on the image feature map for the preset scale is performed, to obtain an upsampled image feature map; where, a scale of each upsampled image feature map is the maximum preset scale.

In this embodiment of the present disclosure, upsampling processing is performed on each image feature map that is less than the maximum preset scale, and after the upsampling processing, all the image feature maps have the maximum preset scale.

At step S420, the image feature map corresponding to the maximum preset scale is sliced and each upsampled image feature map to obtain a second spliced feature map.

In some embodiments, all the image feature maps with the maximum preset scale are spliced to obtain the second spliced feature map.

At step S430, based on the second spliced feature map, the first probability that each pixel in the target image belongs to the foreground and the second probability that each pixel in the target image belongs to the background are determined.

In some embodiments, a neural network layer may be used to process the second spliced feature map, so as to determine, based on image feature information included in a feature pixel in the second spliced feature map, a first probability that a pixel in the target image and corresponding to the feature pixel belongs to the foreground and a second probability that a pixel in the target image and corresponding to the feature pixel belongs to the background.

In the foregoing embodiment, upsampling processing is performed on an image feature map that is less than the maximum preset scale, so that all image feature maps are spliced only after they have the identical scale, thereby ensuring accuracy of feature map splicing, and helping improve accuracy of performing panoramic segmentation on the target image.

In some embodiments, performing panoramic segmentation on the target image based on the plurality of image feature maps, the first probability that each pixel in the target image belongs to the foreground, and the second probability that each pixel in the target image belongs to the background may be implemented by using the following steps S510 to S550.

At step S510, semantic segmentation logits are determined according to the second spliced feature map and the second probability that each pixel in the target image belongs to the background; where, a higher second probability that a pixel in the target image belongs to the background, a larger first scaling ratio corresponding to the pixel, and a first scaling ratio corresponding to a pixel in the target image is the ratio of a value corresponding to the pixel in the semantic segmentation logits to a value corresponding to the pixel in the second spliced feature map.

In this embodiment of the present disclosure, the second probability may be used to enhance feature pixels in the second spliced feature map and corresponding to the background, and then, an enhanced feature map may be used to generate the semantic segmentation logits.

In this embodiment of the present disclosure, the first probability and the second probability are determined after feature extraction is performed on the second spliced feature map, and the first probability and the second probability may correspond to a foreground-background classification feature map, that is, the foreground-background classification feature map includes the first probability and the second probability. That is, the foreground-background classification feature map may be determined by using the first probability that each pixel in the target image belongs to the foreground and the second probability that each pixel in the target image belongs to the background. In this step, the determining semantic segmentation logits based on the second spliced feature map and the second probability that each pixel in the target image belongs to the background may include: extracting an image feature in the foreground-background classification feature map by using a plurality of convolutional layers and hidden layers in a convolutional neural network, to obtain a feature map; enhancing a feature pixel in the feature map and corresponding to the background in the target image, and weakening a feature pixel in the feature map and corresponding to the foreground in the target image, so as to obtain a first processed feature map; fusing the first processed feature map with the second spliced feature map to obtain a fused feature map; and determining the semantic segmentation logits based on the fused feature map. The feature pixel in the target image and corresponding to the background is enhanced in the feature map, and the feature pixel in the target image and corresponding to the foreground is weakened in the feature map. In the fusion step, a feature pixel in the second spliced feature map and corresponding to the background in the target image is enhanced, and a feature pixel in the second spliced feature map and corresponding to the foreground in the target image is weakened. Therefore, in the semantic segmentation logits obtained by fusing the first processed feature map with the second spliced feature map, a feature pixel corresponding to the background in the target image is enhanced, and a feature pixel corresponding to the foreground in the target image is weakened, thereby helping improve accuracy of performing panoramic segmentation on the target image based on the semantic segmentation logits.

At step S520, an initial bounding box, an instance class of each object, and instance segmentation logits of each object in the target image are determined according to the second spliced feature map and the first probability that each pixel in the target image belongs to the foreground; where, a higher first probability that a pixel in the target image belongs to the foreground, a larger second scaling ratio corresponding to the pixel, and a second scaling ratio corresponding to a pixel in the target image is a ratio of a value corresponding to the pixel in the instance segmentation logits to a value corresponding to the pixel in the second spliced feature map.

In this embodiment of the present disclosure, the first probability may be used to enhance features pixel in the second spliced feature map and corresponding to the foreground. Then, an enhanced feature map may be used to generate the instance segmentation logits, and determine the initial bounding box and the instance class of each object in the target image.

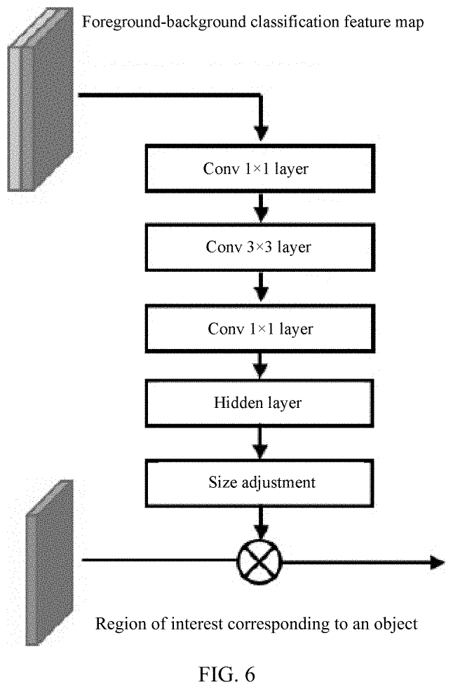

In this embodiment of the present disclosure, the first probability and the second probability are determined after feature extraction is performed on the second spliced feature map, and the first probability and the second probability may correspond to a foreground-background classification feature map, that is, the foreground-background classification feature map includes the first probability and the second probability. That is, the foreground-background classification feature map may be determined by using the first probability that each pixel in the target image belongs to the foreground and the second probability that each pixel in the target image belongs to the background. In this step, as shown in FIG. 6, the determining an initial bounding box, an instance class of each object, and instance segmentation logits of each object in the target image based on the second spliced feature map and the first probability that each pixel in the target image belongs to the foreground may include: extracting an image feature from the foreground-background classification feature map by using a plurality of convolutional layers cony layer and hidden layers Sigmoid layer in a convolutional neural network, to obtain a feature map; enhancing a feature pixel in the feature map and corresponding to the foreground in the target image, and weakening a feature pixel in the feature map and corresponding to the background in the target image, to obtain a second processed feature map; fusing the second processed feature map with a region of interest corresponding to each object in the second spliced feature map to obtain a fused feature map; and determining the initial bounding box of each object, the instance class of each object, and the instance segmentation logits of each object based on the fused feature map. The feature pixel in the feature map and corresponding to the foreground in the target image is enhanced, and the feature pixel in the feature map and corresponding to the background in the target image is weakened, which makes, in the fusion step, a feature pixel in the second spliced feature map and corresponding to the foreground in the target image be enhanced, and a feature pixel in the second spliced feature map and corresponding to the background in the target image be weakened. Therefore, accuracy of determining the initial bounding box of each object, the instance class of each object, and the instance segmentation logits of each object by fusing the second processed feature map with the region of interest corresponding to each object in the second spliced feature map is improved, thereby helping improve accuracy of performing panoramic segmentation on the target image based on the initial bounding box of each object, the instance class of each object, and the instance segmentation logits of each object.

It should be noted that, when the initial bounding box of each object, the instance class of each object, and the instance segmentation logits of each object are determined based on the second spliced feature map and the first probability that each pixel in the target image belongs to the foreground, first, a feature region (that is, the region of interest) of each object in the second spliced feature map is determined, and then, the initial bounding box of each object in the target image, the instance class of each object, and the instance segmentation logits of each object are determined based on the feature region of each object in the second spliced feature map and the first probability that each pixel in the target image belongs to the foreground.

At step S530, for each object, semantic segmentation logits corresponding to the object from the semantic segmentation logits are determined according to the initial bounding box and the instance class of the object.

In this embodiment of the present disclosure, semantic segmentation logits of a region corresponding to the initial bounding box and the instance class of the object is intercepted from the semantic segmentation logits.

At step S540, panoramic segmentation logits of the target image are determined according to the semantic segmentation logits and the instance segmentation logits that correspond to each object.

In this embodiment of the present disclosure, the panoramic segmentation logits for performing panoramic segmentation on the target image can be generated according to the semantic segmentation logits and the instance segmentation logits that correspond to each object.

At step S550, a bounding box and an instance class of an object in the background and the foreground of the target image are determined according to the panoramic segmentation logits of the target image.

In some embodiments, the image processing method is performed by a neural network, the neural network is trained by using sample images, and the sample images include an instance class annotated for an object and mask information annotated for the object. The mask information includes information about whether each pixel in an initial bounding box corresponding to the object is a pixel of the object.

The present disclosure further provides a procedure for training the neural network. In some embodiments, the procedure may include the following steps 1 to 3.

At step 1, a plurality of sample image feature maps of the sample image that correspond to the different preset scales, a first sample probability that each pixel in the sample image belongs to the foreground, and a second sample probability that each pixel in the sample image belongs to the background are determined.

In this embodiment of the present disclosure, the neural network may determine, by using the same method as that in the foregoing embodiment, feature maps of the sample image that correspond to the different preset scales, that is, the plurality of sample image feature maps. The first sample probability that each pixel in the sample image belongs to the foreground, and the second sample probability that each pixel in the sample image belongs to the background may be determined by using the same method as that in the foregoing embodiment.

At step 2, panoramic segmentation is performed on the sample image according to the plurality of sample image feature maps, the first sample probability that each pixel in the sample image belongs to the foreground, and the second sample probability that each pixel in the sample image belongs to the background, to output an instance class and mask information of each object in the sample image.

Mask information of an object in the sample image outputted by the neural network is mask information of the object that is predicted by the neural network, and the mask information of the object that is predicted by the neural network may be determined by using an image in a bounding box of the object that is predicted by the neural network. That is, mask information of an object that is predicted by the neural network may be determined by using the sample image and a bounding box of the object that is predicted by the neural network.

At step 3, a network loss function is determined based on the mask information of each object in the sample image that is outputted by the neural network and mask information annotated for each object. Mask information annotated for an object may be determined by using an image in a bounding box annotated for the object, that is, mask information annotated for an object may be determined by using the sample image and a bounding box annotated for the object.

In this embodiment of the present disclosure, the following sub-steps 1 to 4 may be used to determine the network loss function.

At sub-step 1, the identical information between the mask information of each object in the sample image that is outputted by the neural network and the mask information annotated for each object is determined, to obtain mask intersection information.

At sub-step 2, combined information between the mask information of each object in the sample image that is outputted by the neural network and the mask information annotated for each object is determined, to obtain mask union information.

At sub-step 3, the network loss function is determined based on the mask intersection information and the mask union information.

A mask intersection set and a mask union set are determined by using the annotated mask information and the mask information predicted by the neural network, and the network loss function is further determined based on the mask intersection set and the mask union set, that is, an intersection over union (IOU) loss function. By using the IOU loss function, accuracy of performing panoramic segmentation by the neural network obtained through training can be improved.

At sub-step 4, a network parameter is adjusted in the neural network by using the network loss function.

In this embodiment, the network loss function is determined by using the annotated mask information and the mask information predicted by the neural network, so as to train the neural network by using the network loss function, which can improve accuracy of performing panoramic segmentation by the neural network obtained through training.

The following further describes an image processing method in the present disclosure by using an embodiment.

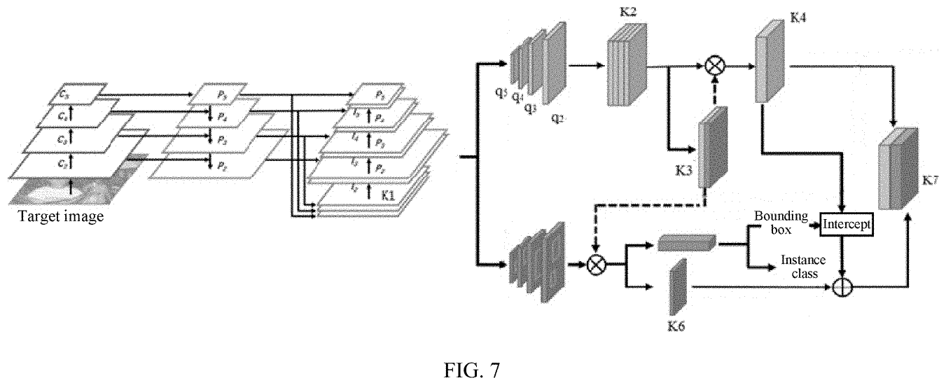

As shown in FIG. 7, the image processing method in this embodiment includes the following steps 700 to 790.

At step 700, a target image is obtained to determine first feature maps p2, p3, p4, and p5 of the target image that correspond to different preset scales.

At step 710, the first feature maps p2, p3, p4, and p5 are sliced, and a second feature map l2 corresponding to the maximum preset scale is determined based on a first spliced feature map K1 obtained through splicing.

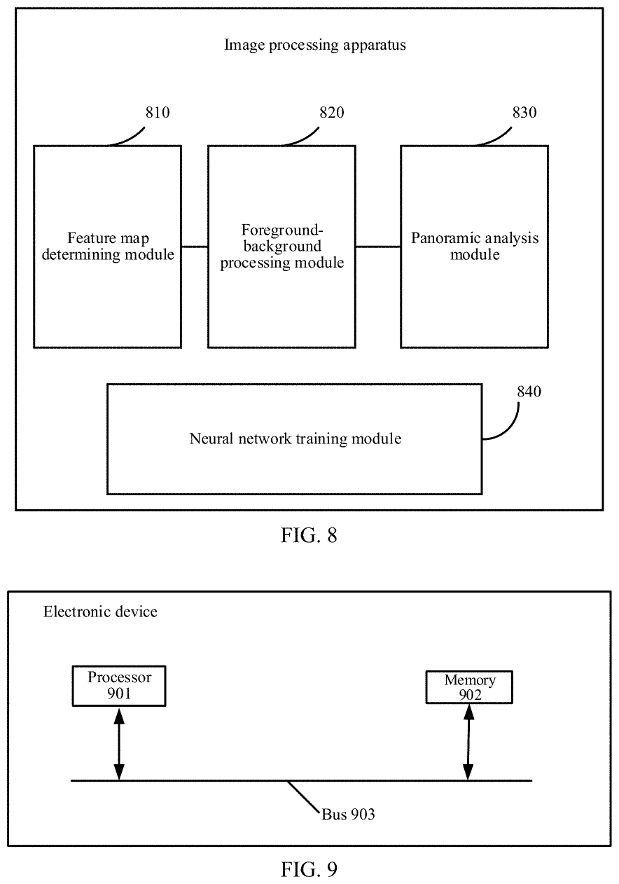

At step 720, for each of the preset scales except the maximum preset scale, a second feature map corresponding to the preset scale is determined based on a first feature map and a second feature map corresponding to a preset scale that is adjacent to the preset scale and that is greater than the preset scale, that is, l3, l4, and l5 in FIG. 8.

At step 730, for each of the preset scales, based on the first feature map corresponding to the preset scale and the second feature map corresponding to the preset scale, image feature maps q2, q3, q4, and q5 of the target image that correspond to the preset scale are determined.

At step 740, for each of the different preset scales except the maximum preset scale, upsampling processing is performed on an image feature map for the preset scale, an upsampled image feature map having the maximum preset scale. Then, all image feature maps corresponding to the maximum preset scale are spliced to obtain a second spliced feature map K2.

At step 750, a foreground-background classification feature map K3 is generated based on the second spliced feature map K2, the foreground-background classification feature map K3 including a first probability that each pixel in the target image belongs to a foreground and a second probability that each pixel in the target image belongs to a background.

At step 760, semantic segmentation logits K4 are determined based on a second probability that each pixel in the foreground-background classification feature map K3 belongs to the background and the second spliced feature map K2.

At step 770, an initial bounding box, an instance class, and an instance segmentation logit K6 of each object in the target image are determined based on a first probability that each pixel in the foreground-background classification feature map K3 belongs to the foreground and the plurality of image feature maps.

At step 780, for each object, semantic segmentation logits corresponding to the object from the semantic segmentation logits are determined based on the initial bounding box and the instance class of the object, and panoramic segmentation logits K7 of the target image are determine according to the semantic segmentation logits and the instance segmentation logits K6 that correspond to each object.

At step 790, a bounding box and an instance class of an object in the background and the foreground of the target image are determined according to the panoramic segmentation logits of the target image.

In the foregoing embodiment, image feature extraction and fusion are performed for a plurality of times and in a plurality of directions, to obtain the image feature maps of the target image that correspond to the different preset scales, so as to fully explore image features of the target image, and the obtained image feature maps include more complete and accurate image features. The more accurate and complete image feature maps help improve accuracy of performing panoramic segmentation on the target image. In the foregoing embodiment, enhancement processing is performed on a feature pixel in the image feature map and corresponding to the background or the foreground based on the first probability that each pixel in the target image belongs to the foreground and the second probability that each pixel in the target image belongs to the background, which is also conducive to accuracy of performing panoramic segmentation on the target image.

Corresponding to the foregoing image processing method, an embodiment of the present disclosure further provides an image processing apparatus. The apparatus is applied to a terminal device for perceiving a scene, that is, performing panoramic segmentation on a target image. In addition, the apparatus and each module of the apparatus can perform the same method steps as the foregoing image processing method, and can achieve the same or similar beneficial effects. Therefore, repeated parts are not described again.

As shown in FIG. 8, the image processing apparatus provided in the present disclosure includes a feature map determining module 810, a foreground-background processing module 820, and a panoramic analysis module 830.

The feature map determining module 810 is configured to determine a plurality of image feature maps of a target image that correspond to different preset scales.

The foreground-background processing module 820 is configured to determine, based on the plurality of image feature maps, a first probability that each pixel in the target image belongs to a foreground and a second probability that each pixel in the target image belongs to a background.

The panoramic analysis module 830 is configured to perform panoramic segmentation on the target image based on the plurality of image feature maps, the first probability that each pixel in the target image belongs to the foreground, and the second probability that each pixel in the target image belongs to the background.

In some embodiments, the feature map determining module 810 is configured to: perform feature extraction on the target image to obtain a first feature map for each of the different preset scales; splice the first feature map of each of the different preset scales to obtain a first spliced feature map; extract an image feature from the first spliced feature map to obtain a second feature map corresponding to the maximum preset scale in the different preset scales; and determine, based on the first feature map for each of the different preset scales and the second feature map corresponding to the maximum preset scale, the plurality of image feature maps of the target image that correspond to the different preset scales.

In some embodiments, when determining, based on the first feature map for each of the different preset scales and the second feature map corresponding to the maximum preset scale, the plurality of image feature maps of the target image that correspond to the different preset scales, the feature map determining module 810 is configured to: for each of the different preset scales except the maximum preset scale, determine a second feature map corresponding to the preset scale based on a first feature map of a preset scale that is adjacent to the preset scale in the different preset scales and that is greater than the preset scale and the second feature map corresponding to the maximum preset scale; and determine, based on the first feature map corresponding to the preset scale and the second feature map corresponding to the preset scale, an image feature map of the target image that corresponds to the preset scale.

In some embodiments, when splicing the first feature map for each of the different preset scales to obtain the first spliced feature map, the feature map determining module 810 is configured to: for each of the different preset scales except the maximum preset scale, perform upsampling processing on the first feature map for the preset scale, to obtain a first upsampled feature map; where a scale of each first upsampled feature map is the maximum preset scale; and splice the first feature map corresponding to the maximum preset scale and each first upsampled feature map to obtain the first spliced feature map.

In some embodiments, the foreground-background processing module 820 is configured to: for each of the different preset scales except the maximum preset scale, perform upsampling processing on the image feature map for the preset scale to obtain an upsampled image feature map; where a scale of each upsampled image feature map is the maximum preset scale; splice the image feature map corresponding to the maximum preset scale and each upsampled image feature maps to obtain a second spliced feature map; and determine, based on the second spliced feature map, the first probability that each pixel in the target image belongs to the foreground and the second probability that each pixel in the target image belongs to the background.

In some embodiments, the panoramic analysis module 830 is configured to: determine semantic segmentation logits according to the second spliced feature map and the second probability that each pixel in the target image belongs to the background; a higher second probability that a pixel in the target image belongs to the background indicates a larger first scaling ratio corresponding to the pixel, and a first scaling ratio corresponding to a pixel in the target image is a ratio of a value corresponding to the pixel in the semantic segmentation logits to a value corresponding to the pixel in the second spliced feature map; determine an initial bounding box, an instance class, and instance segmentation logits of each object in the target image according to the second spliced feature map and the first probability that each pixel in the target image belongs to the foreground; where a higher first probability that a pixel in the target image belongs to the foreground, a larger second scaling ratio corresponding to the pixel, and a second scaling ratio corresponding to a pixel in the target image is a ratio of a value corresponding to the pixel in the instance segmentation logits to a value corresponding to the pixel in the second spliced feature map; for each object, determine semantic segmentation logits corresponding to the object from the semantic segmentation logits according to the initial bounding box and the instance class of the object; determine panoramic segmentation logits of the target image according to the semantic segmentation logits and the instance segmentation logits that correspond to each object; and determine a bounding box and an instance class of an object in the background and the foreground of the target image according to the panoramic segmentation logits of the target image.

When determining the semantic segmentation logits according to the second spliced feature map and the second probability that each pixel in the target image belongs to the background, the panoramic analysis module 830 is configured to: determine a foreground-background classification feature map by using the first probability that each pixel in the target image belongs to the foreground and the second probability that each pixel in the target image belongs to the background; extract an image feature from the foreground-background classification feature map to obtain a feature map; enhance feature pixels in the feature map and corresponding to the background in the target image, and weaken feature pixels in the feature map and corresponding to the foreground in the target image, to obtain a first processed feature map; fuse the first processed feature map with the second spliced feature map to obtain a fused feature map; and determine the semantic segmentation logits based on the fused feature map.

When determining the initial bounding box, the instance class, and the instance segmentation logits of each object in the target image according to the second spliced feature map and the first probability that each pixel in the target image belongs to the foreground, the panoramic analysis module 830 is configured to: determine a foreground-background classification feature map by using the first probability that each pixel in the target image belongs to the foreground and the second probability that each pixel in the target image belongs to the background; extract an image feature from the foreground-background classification feature map to obtain a feature map; enhance feature pixels in the feature map and corresponding to the foreground in the target image, and weaken feature pixels in the feature map and corresponding to the background in the target image, to obtain a second processed feature map; fuse the second processed feature map with a region of interest corresponding to each object in the second spliced feature map to obtain a fused feature map; and determine the initial bounding box of each object, the instance class of each object, and the instance segmentation logits of each object based on the fused feature map.

In some embodiments, the apparatus for image processing performs panoramic segmentation on the target image by using a neural network, the neural network is trained by using a sample image, and the sample image includes an instance class annotated for an object and mask information annotated for the object.

In some embodiments, the apparatus further includes a neural network training module 840, and the neural network training module 840 trains the neural network by using the following steps include: determining a plurality of sample image feature maps of the sample image that correspond to the different preset scales, a first sample probability that each pixel in the sample image belongs to the foreground, and a second sample probability that each pixel in the sample image belongs to the background; performing panoramic segmentation on the sample image according to the plurality of sample image feature maps, the first sample probability that each pixel in the sample image belongs to the foreground, and the second sample probability that each pixel in the sample image belongs to the background, to output an instance class and mask information of each object in the sample image; determining a network loss function based on the mask information of each object in the sample image that is outputted by the neural network and mask information annotated for each object; and adjusting a network parameter in the neural network by using the network loss function.

In some embodiments, when determining the network loss function based on the mask information of each object in the sample image that is outputted by the neural network and the mask information annotated for each object, the neural network training module 840 is configured to: determine identical information between the mask information of each object in the sample image that is outputted by the neural network and the mask information annotated for each object, to obtain mask intersection information; determine combined information between the mask information of each object in the sample image that is outputted by the neural network and the mask information annotated for each object, to obtain mask union information; and determine the network loss function based on the mask intersection information and the mask union information.

An embodiment of the present disclosure discloses an electronic device. As shown in FIG. 9, the electronic device includes a processor 901, a memory 902, and a bus 903. The memory 902 stores machine readable instructions executable by the processor 901. When the electronic device runs, the processor 901 communicates with the memory 902 by using the bus 903.

When the machine readable instructions are executed by the processor 901, the image processing method provided in any one of the foregoing embodiments is performed.

An embodiment of the present disclosure further provides a computer program product corresponding to the foregoing method and apparatus, including a computer readable storage medium storing program codes. Instructions included in the program codes may be used to perform the method in the foregoing method embodiment. For particular implementation, refer to the method embodiments. Details are not described herein again.

An embodiment of the present disclosure further provides a computer program stored in a storage medium, and when the computer program is run by a processor, the image processing method in any one of the foregoing embodiments is performed.

The foregoing descriptions of the embodiments tend to emphasize differences between the embodiments. For the same or similar description, reference may be made to each other. For brevity, details are not described in this specification.

A person skilled in the art can clearly understand that for convenience and conciseness of description, for particular working processes of the foregoing described system and apparatus, refer to the corresponding processes in the method embodiments, and details are not described herein. In the embodiments provided in the present disclosure, it is to be understood that the disclosed system, apparatus, and method may be implemented in other manners. For example, the apparatus embodiment described above is merely exemplary. For example, the partition of modules is merely a partition of logical functions and there may be other partition modes in actual implementation. For example, a plurality of modules or components may be combined or may be integrated to another system, or some characteristics may be ignored or not performed. In addition, the displayed or discussed mutual couplings or direct couplings or communication connections may be implemented by using some communication interfaces. The indirect couplings or communication connections between the apparatuses or modules may be implemented in electronic, mechanical, or other forms.

The modules described as separate components may or may not be physically separated, and the components displayed as modules may or may not be physical units, i.e., may be located in one place or may be distributed over multiple network units. Some or all of the units may be selected according to actual requirements to achieve the objectives of the solutions in the embodiments.

In addition, functional units in the embodiments of the present disclosure may be integrated into one processing unit, or each of the units may be physically separated, or two or more units may be integrated into one unit.

If implemented in the form of software functional units and sold or used as an independent product, the functions may also be stored in a non-volatile processor-executable computer-readable storage medium. Based on such an understanding, the technical solutions of the present disclosure essentially, or the part contributing to the prior art, or a part of the technical solutions may be embodied in the form of a software product. The computer software product is stored in a storage medium and includes several instructions for instructing a computer device (which may be a PC, a server or a network device and the like) to perform all or some of the steps of the methods described in the embodiments of the present disclosure. The foregoing storage medium includes: any medium that can store program codes, such as a USB flash drive, a removable hard disk, a ROM (Read-Only Memory, read-only memory), a RAM (Random Access Memory), a magnetic disk, or an optical disc.

The foregoing descriptions are merely detailed description of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the appended claims.

1. An image processing method, comprising:
determining a plurality of image feature maps of a target image, the plurality of image feature maps corresponding to different preset scales;
determining, based on the plurality of image feature maps and for each pixel of pixels in the target image, a first probability that the pixel in the target image belongs to a foreground and a second probability that the pixel in the target image belongs to a background; and
performing panoramic segmentation on the target image based on the plurality of image feature maps, the first probabilities of the pixels in the target image, and the second probabilities of the pixels in the target image.

2. The image processing method according to claim 1, wherein determining the plurality of image feature maps of the target image comprises:
performing feature extraction on the target image to obtain a respective first feature map for each of the different preset scales;
splicing the respective first feature maps for the different preset scales to obtain a first spliced feature map;
extracting an image feature from the first spliced feature map to obtain a second feature map corresponding to a maximum preset scale in the different preset scales; and
determining, based on the respective first feature maps for the different preset scales and the second feature map corresponding to the maximum preset scale, the plurality of image feature maps corresponding to the different preset scales.

3. The image processing method according to claim 2, wherein determining, based on the respective first feature maps for the different preset scales and the second feature map corresponding to the maximum preset scale, the plurality of image feature maps corresponding to the different preset scales comprises:
for each of the different preset scales except the maximum preset scale,
determining, based on the second feature map corresponding to the maximum preset scale and the respective first feature map for an adjacent preset scale that is adjacent to the preset scale and greater than the preset scale in the different preset scales, a second feature map corresponding to the preset scale; and
determining, based on the respective first feature map corresponding to the preset scale and the second feature map corresponding to the preset scale, an image feature map corresponding to the preset scale.

4. The image processing method according to claim 2, wherein splicing the respective first feature maps for the different preset scales to obtain a first spliced feature map comprises:
for each of the different preset scales except the maximum preset scale, performing upsampling processing on the respective first feature map for the preset scale to obtain a first upsampled feature map having a scale identical to the maximum preset scale; and
splicing the respective first feature map corresponding to the maximum preset scale and the first upsampled feature maps for the different preset scales except the maximum preset scales to obtain the first spliced feature map.

5. The image processing method according claim 1, wherein determining, based on the plurality of image feature maps and for each pixel in the target image, the first probability that the pixel in the target image belongs to the foreground and the second probability that the pixel in the target image belongs to the background comprises:
for each of the different preset scales except a maximum preset scale, performing upsampling processing on an image feature map corresponding to the preset scale to obtain an upsampled image feature map having a scale identical to the maximum preset scale;
splicing an image feature map corresponding to the maximum preset scale and the upsampled image feature maps for the different preset scales except the maximum preset scale to obtain a second spliced feature map; and
determining, based on the second spliced feature map and for each pixel in the target image, the first probability that the pixel in the target image belongs to the foreground and the second probability that the pixel in the target image belongs to the background.

6. The image processing method according to claim 5, wherein performing panoramic segmentation on the target image based on the plurality of image feature maps, the first probabilities for the pixels in the target image, and the second probabilities for the pixels in the target image comprises:
determining semantic segmentation logits according to the second spliced feature map and the second probabilities for the pixels in the target image, wherein a first scaling ratio corresponding to a pixel in the target image is a ratio of a value corresponding to the pixel in the semantic segmentation logits to a value corresponding to the pixel in the second spliced feature map, and wherein a pixel in the target image having a higher second probability corresponds to a larger first scaling ratio;
determining an initial bounding box, an initial instance class, and instance segmentation logits of each object in the target image according to the second spliced feature map and the first probabilities for the pixels in the target image, wherein a second scaling ratio corresponding to a pixel in the target image is a ratio of a value corresponding to the pixel in the instance segmentation logits to a value corresponding to the pixel in the second spliced feature map, and wherein a pixel in the target image having a higher first probability corresponds to a larger second scaling ratio;
for each object in the target image, determining respective semantic segmentation logits corresponding to the object from the semantic segmentation logits according to the initial bounding box and the initial instance class of the object;
determining panoramic segmentation logits of the target image according to the respective semantic segmentation logits and the instance segmentation logits that correspond to each object; and
determining a bounding box and an instance class of each of objects in the background and the foreground of the target image according to the panoramic segmentation logits of the target image.

7. The image processing method according to claim 6, wherein determining the semantic segmentation logits according to the second spliced feature map and the second probabilities of the pixels in the target image comprises:
determining a foreground-background classification feature map by using the first probabilities of the pixels in the target image and the second probabilities of the pixels in the target image;
extracting an image feature from the foreground-background classification feature map to obtain a feature map;
obtaining a first processed feature map by enhancing feature pixels that are in the feature map and correspond to the background in the target image and weakening feature pixels that are in the feature map and correspond to the foreground in the target image;
fusing the first processed feature map with the second spliced feature map to obtain a fused feature map; and
determining the semantic segmentation logits based on the fused feature map.

8. The image processing method according to claim 6, wherein determining an initial bounding box, an initial instance class, and instance segmentation logits of each object in the target image according to the second spliced feature map and the first probabilities of the pixels in the target image comprises:
determining a foreground-background classification feature map by using the first probabilities of the pixels in the target image and the second probabilities of the pixels in the target image;
extracting an image feature from the foreground-background classification feature map to obtain a feature map;
obtaining a second processed feature map by enhancing feature pixels that are in the feature map and correspond to the foreground in the target image and weakening feature pixels that are in the feature map and correspond to the background in the target image;
fusing the second processed feature map with a region of interest corresponding to each object in the second spliced feature map to obtain a fused feature map; and
for each object in the target image, determining the initial bounding box, the initial instance class, and the instance segmentation logits based on the fused feature map.

9. The image processing method according to claim 1, wherein the image processing method is performed by a neural network that is trained by using a sample image, and
wherein the sample image comprises an instance class and mask information annotated for each object in the sample image.

10. The method according to claim 9, wherein the neural network is trained by:
determining a plurality of sample image feature maps of the sample image, the plurality of sample image feature maps corresponding to the different preset scales;
determining, for each pixel of pixels in the sample image, a first sample probability that the pixel in the sample image belongs to the foreground and a second sample probability that the pixel in the sample image belongs to the background;
performing panoramic segmentation on the sample image according to the plurality of sample image feature maps, the first sample probabilities of the pixels in the sample image, and the second sample probabilities of the pixels in the sample image to output an instance class and mask information of each object in the sample image;
determining a network loss function based on the mask information of each object in the sample image that is outputted by the neural network and mask information annotated for each object in the sample image; and
adjusting a network parameter in the neural network by using the network loss function.

11. The method according to claim 10, wherein determining the network loss function based on the mask information of each object in the sample image that is outputted by the neural network and mask information annotated for each object comprises:
obtaining mask intersection information by determining, for each object in the sample image, identical information between the mask information outputted by the neural network and the mask information annotated in the sample image;
obtaining mask union information by determining, for each object in the sample image, combined information between the mask information outputted by the neural network and the mask information annotated in the sample image; and
determining the network loss function based on the mask intersection information and the mask union information.

12. An electronic device, comprising:
at least one processor; and
one or more memories coupled to the at least one processor and storing programming instructions for execution by the at least one processor to perform operations comprising:
determining a plurality of image feature maps of a target image, the plurality of image feature maps corresponding to different preset scales;
determining, based on the plurality of image feature maps and for each pixel of pixels in the target image, a first probability that the pixel in the target image belongs to a foreground and a second probability that the pixel in the target image belongs to a background; and
performing panoramic segmentation on the target image based on the plurality of image feature maps, the first probabilities of the pixels in the target image, and the second probabilities of the pixels in the target image.

13. The electronic device according to claim 12, wherein determining the plurality of image feature maps of the target image comprises:
performing feature extraction on the target image to obtain a respective first feature map for each of the different preset scales;
splicing the respective first feature maps for the different preset scales to obtain a first spliced feature map;
extracting an image feature from the first spliced feature map to obtain a second feature map corresponding to a maximum preset scale in the different preset scales; and
determining, based on the respective first feature maps for the different preset scales and the second feature map corresponding to the maximum preset scale, the plurality of image feature maps corresponding to the different preset scales.

14. The electronic device according to claim 13, wherein determining, based on the respective first feature maps for the different preset scales and the second feature map corresponding to the maximum preset scale, the plurality of image feature maps corresponding to the different preset scales comprises:
for each of the different preset scales except the maximum preset scale,
determining, based on the second feature map corresponding to the maximum preset scale and the respective first feature map for an adjacent preset scale that is adjacent to the preset scale and greater than the preset scale in the different preset scales, a second feature map corresponding to the preset scale; and
determining, based on the respective first feature map corresponding to the preset scale and the second feature map corresponding to the preset scale, an image feature map corresponding to the preset scale.

15. The electronic device according to claim 13, wherein splicing the respective first feature maps for the different preset scales to obtain a first spliced feature map comprises:
for each of the different preset scales except the maximum preset scale, performing upsampling processing on the respective first feature map for the preset scale to obtain a first upsampled feature map having a scale identical to the maximum preset scale; and
splicing the respective first feature map corresponding to the maximum preset scale and the first upsampled feature maps for the different preset scales except the maximum preset scales to obtain the first spliced feature map.

16. The electronic device according to claim 12, wherein determining, based on the plurality of image feature maps and for each pixel in the target image, the first probability that the pixel in the target image belongs to the foreground and the second probability that the pixel in the target image belongs to the background comprises:
for each of the different preset scales except a maximum preset scale, performing upsampling processing on an image feature map corresponding to the preset scale to obtain an upsampled image feature map having a scale identical to the maximum preset scale;
splicing an image feature map corresponding to the maximum preset scale and the upsampled image feature maps for the different preset scales except the maximum preset scale to obtain a second spliced feature map; and
determining, based on the second spliced feature map and for each pixel in the target image, the first probability that the pixel in the target image belongs to the foreground and the second probability that the pixel in the target image belongs to the background.

17. The electronic device according to claim 16, wherein performing panoramic segmentation on the target image based on the plurality of image feature maps, the first probabilities for the pixels in the target image, and the second probabilities for the pixels in the target image comprises:
determining semantic segmentation logits according to the second spliced feature map and the second probabilities for the pixels in the target image, wherein a first scaling ratio corresponding to a pixel in the target image is a ratio of a value corresponding to the pixel in the semantic segmentation logits to a value corresponding to the pixel in the second spliced feature map, and wherein a pixel in the target image having a higher second probability corresponds to a larger first scaling ratio;
determining an initial bounding box, an initial instance class, and instance segmentation logits of each object in the target image according to the second spliced feature map and the first probabilities for the pixels in the target image, wherein a second scaling ratio corresponding to a pixel in the target image is a ratio of a value corresponding to the pixel in the instance segmentation logits to a value corresponding to the pixel in the second spliced feature map, and wherein a pixel in the target image having a higher first probability corresponds to a larger second scaling ratio;
for each object in the target image, determining respective semantic segmentation logits corresponding to the object from the semantic segmentation logits according to the initial bounding box and the initial instance class of the object;
determining panoramic segmentation logits of the target image according to the respective semantic segmentation logits and the instance segmentation logits that correspond to each object; and
determining a bounding box and an instance class of each of objects in the background and the foreground of the target image according to the panoramic segmentation logits of the target image.

18. The electronic device according to claim 17, wherein determining the semantic segmentation logits according to the second spliced feature map and the second probabilities of the pixels in the target image comprises:
determining a foreground-background classification feature map by using the first probabilities of the pixels in the target image and the second probabilities of the pixels in the target image;
extracting an image feature from the foreground-background classification feature map to obtain a feature map;
obtaining a first processed feature map by enhancing feature pixels that are in the feature map and correspond to the background in the target image and weakening feature pixels that are in the feature map and correspond to the foreground in the target image;
fusing the first processed feature map with the second spliced feature map to obtain a fused feature map; and
determining the semantic segmentation logits based on the fused feature map.

19. The electronic device according to claim 17, wherein determining an initial bounding box, an initial instance class, and instance segmentation logits of each object in the target image according to the second spliced feature map and the first probabilities of the pixels in the target image comprises:
determining a foreground-background classification feature map by using the first probabilities of the pixels in the target image and the second probabilities of the pixels in the target image;
extracting an image feature from the foreground-background classification feature map to obtain a feature map;
obtaining a second processed feature map by enhancing feature pixels that are in the feature map and correspond to the foreground in the target image and weakening feature pixels that are in the feature map and correspond to the background in the target image;
fusing the second processed feature map with a region of interest corresponding to each object in the second spliced feature map to obtain a fused feature map; and
for each object in the target image, determining the initial bounding box, the initial instance class, and the instance segmentation logits based on the fused feature map.

20. A non-transitory computer readable storage medium coupled to at least one processor and having machine-executable instructions stored thereon that, when executed by the at least one processor, cause the at least one processor to perform operations comprising:
determining a plurality of image feature maps of a target image, the plurality of image feature maps corresponding to different preset scales;
determining, based on the plurality of image feature maps and for each pixel of pixels in the target image, a first probability that the pixel in the target image belongs to a foreground and a second probability that the pixel in the target image belongs to a background; and
performing panoramic segmentation on the target image based on the plurality of image feature maps, the first probabilities of the pixels in the target image, and the second probabilities of the pixels in the target image.
